(19) United States
(12) Patent Application Publication
(10) Pub. No.: US 2018/0139485 A1
(43) Pub. Date: May 17, 2018

(54) Camera System for Car Security

(71) Applicants: Mohammed Tauqeer Ansari, San Ramon, CA (US); William Allen Gatliff, Dunlap, IL (US)

(72) Inventors: Mohammed Tauqeer Ansari, San Ramon, CA (US); William Allen Gatliff, Dunlap, IL (US)

(21) Appl. No.: 15/567,069

(22) PCT Filed: Jun. 25, 2015
(86) PCT No.: PCT/US15/37837

§ 371 Date: Oct. 16, 2017

Related U.S. Application Data
(60) Provisional application No. 62/150,955, filed on Apr. 22, 2015.

(51) Int. Cl. H04N 21/2743; H04N 5/232; H04N 21/414; H04N 21/4223; H04N 21/422

(52) U.S. Cl. CPC H04N 21/2743; H04N 5/23238; G06K 9/00288; H04N 21/4223; H04N 21/42202; H04N 21/41422

(57) ABSTRACT

A system and method is provided for vehicle surveillance. A panoramic camera is set up within the vehicle and configured to capture images within the vehicle and outside of the vehicle through windows of the vehicle. Upon capturing the images or within a short time thereafter the camera uploads at least one image to a network storage and/or to a monitoring device where the image may be analyzed and appropriate response taken.

### CROSS REFERENCE TO RELATED APPLICATIONS

This application is a continuation-in-part of and claims the benefit of the filing date of U.S. provisional patent application Ser. No. 62/150,955 (the '955 application) entitled “GOTCHA”, which was filed on Apr. 22, 2015 by the same inventor of this application. The '955 application is hereby incorporated by reference as if fully set forth herein.

### FIELD OF THE INVENTION

This disclosure relates generally to automotive security solutions and more particularly but not exclusively to systems and methods for automobile surveillance using a combination of a panoramic camera, an Internet connection and a sensor.

### BACKGROUND OF THE INVENTION

Conventional dash cameras in vehicles are stand-alone cameras which provide a single view in the direction in which the camera is facing. They typically do not include motion detection, nor do they provide 360 degree panoramic views of the car. Additionally, they are not connected to a remote location such as the Cloud. As such, conventional dash cameras are not sufficient to act as security systems for a vehicle.

It would be advantageous to create a 360 degree panoramic camera for a vehicle that could provide video surveillance for the vehicle. It would be further advantageous to create such a camera which was activated based on an environmental change such as motion, sound, and/or proximity of an object and which automatically uploads images to the Cloud for review and/or monitoring.

### BRIEF SUMMARY OF THE INVENTION

Many advantages of the invention will be determined and are attained by the invention, which in a broad sense provides vehicle surveillance solutions. In one or more embodiments a 360 degree panoramic camera is provided. The camera may include an audio microphone and may include a global positioning system (GPS) or some other location acquisition method such as Wireless Local Area Network (“WLAN”) based methods. The camera is capable of taking video and still images. The camera can be configured to operate on a periodic basis (e.g. every 15 seconds) and/or as a result of movement (e.g. if someone or something bumps into or crashes into the vehicle, leans on the vehicle, opens a door, etc.). Additionally or alternatively, the camera may be configured to operate in response to someone or something moving within a certain distance of the vehicle (e.g. 6 inches, a foot, etc.) and/or based on a noise level that rises above a predetermined threshold within the vehicle. Upon operating, the camera 20 immediately uploads at least one still image to a cloud based storage where the image may be reviewed by the owner and/or a monitoring service and/or it may be configured to send the image(s) to a mobile device (e.g. a user's smart phone or laptop computer). When the camera comes into range of an available WiFi signal it may upload the full video. “Always ON” connectivity when the camera device is in the armed/image capture state is desirable whenever possible and power consumption constraints allow the connection to be established and maintained. A caching algorithm may be implemented that balances the storage cost and risk due to data transmission failures.

In one or more implementations of the invention, a vehicle surveillance system is provided. The system includes a camera located within the vehicle and configured to capture panoramic images. The camera has a standby mode and an image capture mode. The system also includes a network connection and a sensor in electrical communication with the camera. The camera is configured to change from standby mode to image capture mode in response to receipt of a signal from the sensor and to upload via the network connection at least one captured image for receipt by a network based storage device or a monitoring device.

In one or more implementations of the invention, a method for vehicle surveillance is provided. The method includes setting up a panoramic camera within the vehicle and setting the camera to standby mode. The camera receives a signal indicating a triggering event has occurred and upon receiving the signal, the camera capturing at least one image and uploading the image to a network based device.

The invention will next be described in connection with certain illustrated embodiments and practices. However, it will be clear to those skilled in the art that various modifications, additions and subtractions can be made without departing from the spirit or scope of the claims.

### BRIEF DESCRIPTION OF THE DRAWINGS

For a better understanding of the invention, reference is made to the following description, taken in conjunction with the accompanying drawings, in which like reference characters refer to like parts throughout, and in which:

FIG. 1 is a block diagram illustrating a vehicle surveillance system in accordance with one or more embodiments of the invention;

FIG. 2 is a block diagram of an alternate embodiment of the vehicle surveillance system of FIG. 1;

FIG. 3 is a flow chart illustrating a method for surveilling a vehicle in accordance with one or more embodiments of the invention;

FIG. 4 is a flow chart illustrating an alternate operation of vehicle surveillance system in accordance with one or more embodiments of the invention.

The invention will next be described in connection with certain illustrated embodiments and practices. However, it will be clear to those skilled in the art that various modifications, additions, and subtractions can be made without departing from the spirit or scope of the claims.

### DETAILED DESCRIPTION OF THE INVENTION

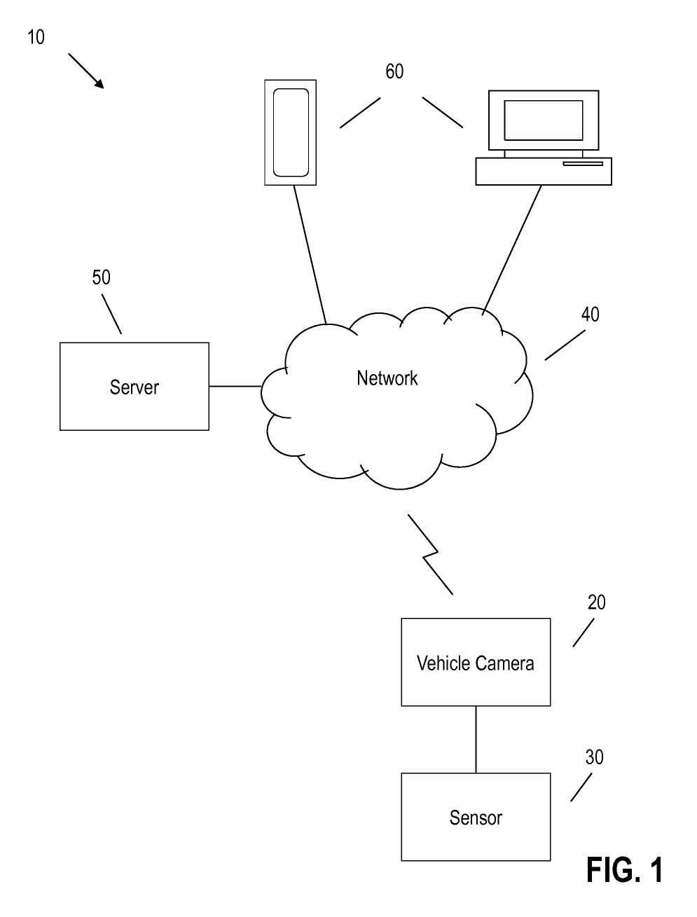

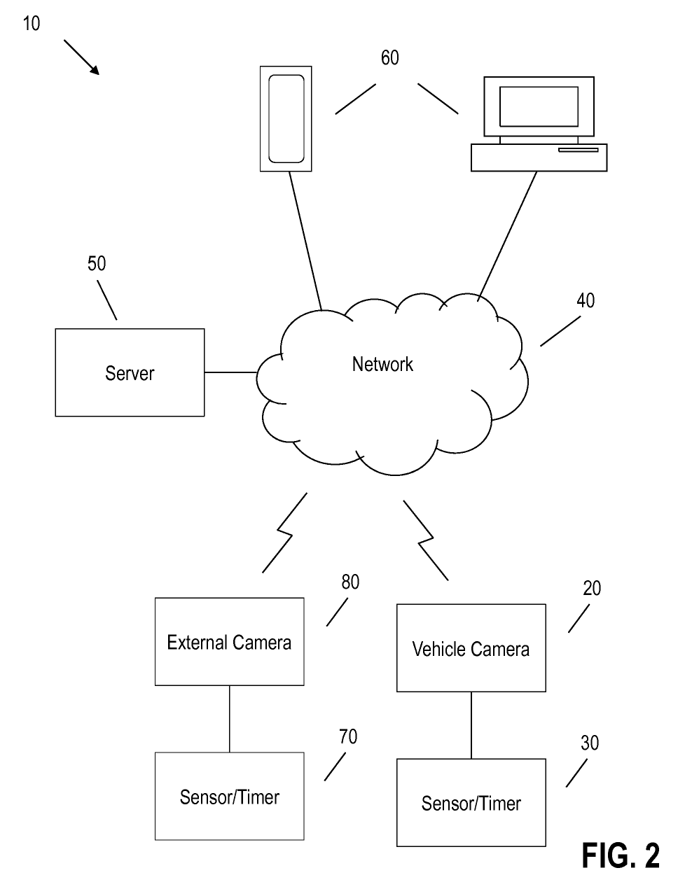

Referring to the drawings in detail wherein like reference numerals identify like elements throughout the various figures, there is illustrated in FIGS. 1-4 a vehicle surveillance system 10. The vehicle can be any vehicle such as a car, truck, plane, boat, helicopter, camper, motorcycle, etc. While the following description will be limited to a car, that is for simplicity purposes only. The description will be equally applicable to any other vehicle. Additionally, while only a very limited number of system elements (e.g. cameras 10, servers 50, monitoring devices 60, networks 40, sensors 30 etc.) are illustrated, those skilled in the art will recognize this is only done for illustration purposes and that the invention is not so limited. The surveillance system may be employed for multiple vehicles, may include multiple cameras 10, multiple sensors 30, multiple monitoring devices 60, and/or multiple servers 50 and can operate over multiple networks 40 or over a single network 40. While the system may operate over different networks, the following description will be limited to the Internet/Cloud. Those skilled in the art will recognize that the following description with minor modifications that are within the purview of those skilled in the art will be equally applicable to those other networks as well.

By way of a non-limiting example, the surveillance solution may operate over one or more of the Internet, a wireless network, a private network, etc. and it/they may be secure or unsecure and still fall within a scope of one or more embodiments of the invention. Additionally, a user may employ multiple cameras 20 and/or sensors 30 on the same vehicle or on multiple vehicles (e.g. a fleet of limousines, etc.). The system 10 may also be configured to transmit images (video and/or still) and/or alerts (e.g. email notifications) and/or audio to one or more monitoring devices 60 which may include smart phones, desktop computers, laptops, tablet computers, smart watches, etc.

Principles and operations of the invention may be better understood with reference to the drawings and the accompanying description. The following description will be limited to a preferred embodiment(s), but the invention is not intended to be limited to that/those embodiments. Those skilled in the art will recognize that various mechanical and electrical modifications to the described embodiments may occur without departing from a scope of the claims.

In the following description, the word image may shall be used in its broadest sense to mean either still images, video images or both with the caveat that in the event that whichever meaning is more appropriate for the reference and whichever provides a broad scope for the reference but does not cause the reference to be ambiguous or rendered obvious by existing references shall govern.

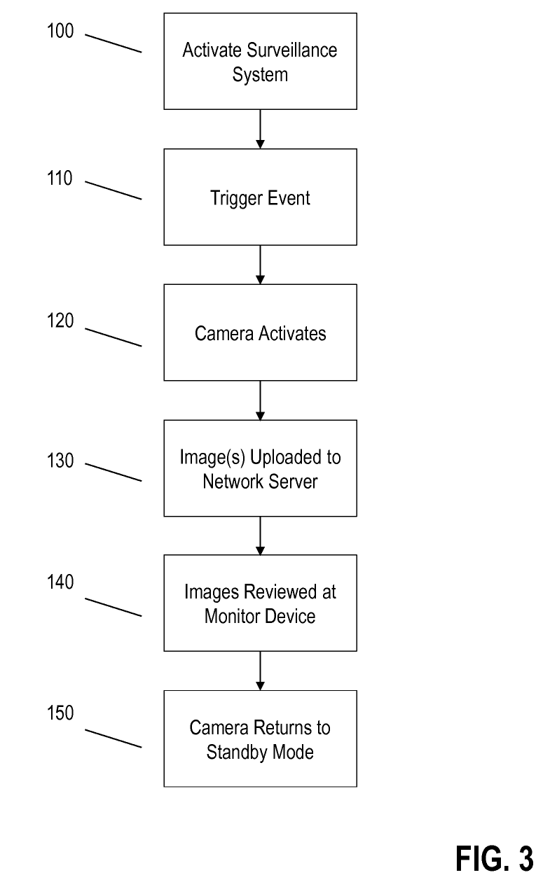

In a preferred embodiment as illustrated in FIGS. 1 and 3 a vehicle surveillance system 10 is provided which enables 360 degree monitoring of the interior and at least a partial monitoring of an exterior of the vehicle (depending upon window configuration of the vehicle, and any other potential obstacles that may obstruct the view from within the vehicle). The system 10 includes a video camera 20 such as a digital single-lens reflex (“DSLR”) camera with a 360 degree panoramic lens. Those skilled in the art will recognize that multiple variations of digital cameras 20 exist which provide 360 degree panoramic capabilities, and not all of them employ a 360 degree panoramic lens. Some employ multiple lenses facing different directions and then combine the images into a panoramic image. Thus, any camera 20 that is capable of 360 degree digital video images is considered to fall within a scope of one or more of the claims. In a preferred embodiment, the camera 20 also includes night vision capabilities and a microphone for capturing audio signals, although it is contemplated by the inventors that a camera 20 without night vision or audio capabilities may be employed and still fall within a scope of one or more of the claims. It is also considered within a scope of one or more of the claims that the camera 20 is actually multiple cameras each with different angles of view wherein the images from the various cameras are combined to form a panoramic image/video of the vehicle. It is also contemplated by the inventor that the system 10 includes an additional portable camera 20 such as a wireless pinhole camera that can be set up outside of the car for an external perspective of the vehicle. Pinhole cameras may be very small and thus can be located inconspicuously outside the vehicle (e.g. in a bush, tree, on a ledge, etc.) to provide another vantage point from which to surveil the vehicle. In such a configuration, the pinhole camera 20 or the system could include a proximity sensor to detect the proximity of the pinhole camera 20 to the vehicle such that when the distance to the pinhole camera exceeds a predetermined distance from the vehicle an alert is provided so the driver of the vehicle does not forget to reacquire the pinhole camera.

The camera 20 includes or is connected to a local storage device such as a digital video recorder (“DVR”), magnetic tape, optical disk, etc. Since audio and storage for a digital camera is conventional technology, they will not be further described herein. Those skilled in the art are deemed to be fully aware of the technology required for capturing and storing audio with a digital video camera and storing the same in a local storage device. In a preferred embodiment, the camera 20 also includes the ability to take digital still images. This technology is also conventional and thus will not be described further herein. The camera 20 may be powered by a rechargeable battery that may be recharged by a solar power source and/or the car battery. Once again, this is conventional technology and will not be described further herein. The camera 20 may include or be connected to a timer such that every predetermined time period (e.g. every 15 seconds or some other time period) or at random time periods the camera 20 activates, takes a predetermined number of still images and/or a certain amount of video and then returns to a waiting state. In one or more preferred embodiments, the system 10 includes one or more sensors such as motion, gyroscope, accelerometer, audio and/or proximity which are used to activate the camera 20. The sensors 30 may be stand-alone sensors 30 which may be hardwired to the camera, they may communicate wirelessly with the camera 20 or they may be integral with the camera 20. Finally, the camera may include or be connected to one or more network interfaces and support multiple communication protocols such as Bluetooth, Firewire, Universal Serial Bus (USB), a wireless Local area network (“LAN”), the Internet/Cloud or some other Wide Area Network (“WAN”), a cellular network, a satellite network, some other peer-to-peer network (“P2P”) and/or the weave protocol part of the Google Brillo operating system for the Internet of Things (“IoT”) segment. This would allow for maximum interoperability with a multitude of sensors and devices and creating value by adding meta-information that aides in hybrid service deployments. The camera is preferably, but not required to be, integrated with the rear view mirror of the vehicle. It is also contemplated that the camera 20 may be a stand-alone device that is attachable to the dashboard, the front or rear windshield, the rearview mirror, the ceiling of the vehicle, a headrest or some other location within the vehicle. It is also contemplated that the camera 20 may be integrated with the headrest of the vehicle.

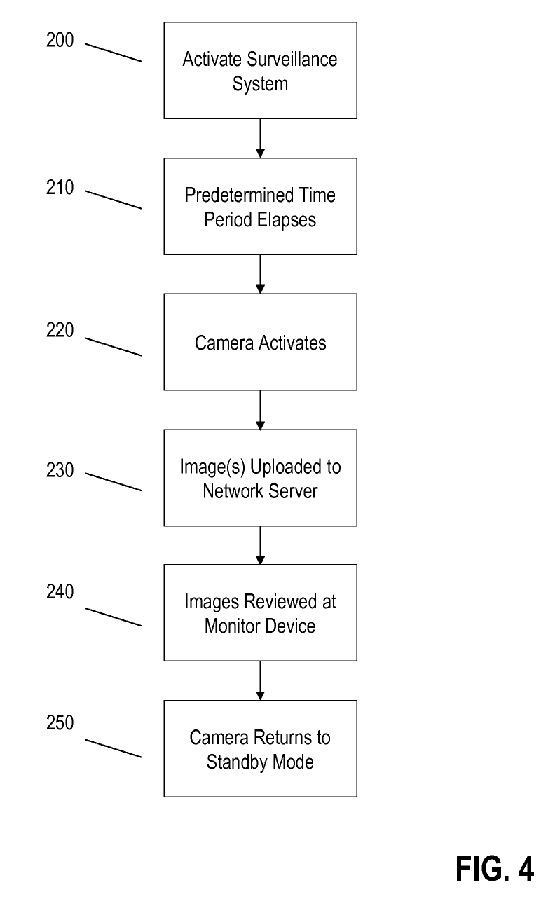

In operation (FIGS. 3 and 4), depending on the design choices of the system, the camera 20 may initially be place into standby mode 100/200 with a trigger event 110/210 that causes it to begin capturing images 120/220 (e.g. in response to movement detected by the motion sensor 30 that exceeds a threshold, detection by the audio sensor 30 of audio within the car that exceeds a certain decibel threshold and/or detection by the proximity sensor that someone or something has come within a predetermined distance to the proximity sensor 30). Upon activation, the camera 20 begins to capture video and/or still images and immediately uploads at least one image 130/230 to the network 40. Those skilled in the art will recognize that the image(s) may be delayed by a relatively short period of time (e.g. within 1 minute or so) and still fall within a scope of the invention. Progressive image data transfer supported by existing protocols like HTTP may be supported. This is one possible manner to enhance resilience of image transfer. The images (still and video) captured by the camera 20 should include a time and date stamp and may be stored locally and/or uploaded to a Cloud based storage 50 and shared with one or more monitoring devices 60 either directly or via server 50. Other metadata transmitted with the image may include the VIN number of the vehicle, location coordinates, temperature . . . etc. Additionally, optional information elements that serve as event markers may, but are not required to, be inserted into the video encoding process. These event markers may allow decoding and seeking to events of interest in a captured video. Preferably the uploaded image(s) will include at least the face of a person who caused the triggering event, although the image(s) preferably will include a full panoramic image or images taken during a specified time period (e.g. for the first 15-20 seconds of camera activation) and will include images of all people within a range of the camera 20. Once uploaded, the image(s) is reviewed 140/240 at a monitor device 60 to determine if further action is required (similar to the service provided by Onstar® only with the addition of image capability). If applicable, the image(s) may be analyzed with facial recognition software (or some other analytics software such as 3VR, etc.) to determine if one or more persons near the car has a criminal record or is otherwise of interest.

Once the situation is either dismissed as a false positive or the situation is escalated to the proper threat response level (e.g. contact police, contact vehicle owner, do nothing but continue to monitor images, etc. and continue capturing images until police arrive or until the owner of the vehicle provides the all clear), the system is returned to standby mode 150/250).

In one or more embodiments of the invention, various systems may act as a private network. In other words, if two or more vehicles are both using the described system, and they are within a certain proximity of each other (as determined by GPS, or proximity sensor or P2P communications—design choices) it may be possible for them to share information, such as triggering events and follow-up images thus providing additional vantage points for the surveillance. In such a situation, it is contemplated by the inventor that each system will include a unique identifier (e.g. the vehicle identification number (“VIN”) of the vehicle) which it would share with other surrounding devices along with possibly other handshaking information. In the event of a triggering event, each camera would activate and upload the resulting image(s) along with the id of the system that recorded the triggering event. In this way, the uploaded images from the non-triggered system could be properly routed to the correct storage and monitoring device(s). A camera will preferably only be associated with one VIN at any given time (although it those skilled in the art will recognize that multiple VINs could be associated with the same camera under certain situations (e.g. when one vehicle trailers another vehicle, etc.). A setup process will register the camera to the Cloud service and provide a binding between camera and owner, VIN number and registered owner of the vehicle. Without this setup/registration process, the surveillance system may, but is not required to, be configured to operate without full service levels and benefits. Additionally, or alternatively, one camera could send the video that it captured to another camera and that other camera could store the video (at least temporarily) until it has an opportunity to upload that video to the network. In this way, there is less opportunity for the video to be tampered with or destroyed. Captured images may be encrypted and an attempt will be made to ensure that the recorded data or its metadata cannot be tampered with during the entire end to end data transfer process.

Additionally, the system may identify fixed security camera devices (e.g. business parking lot cameras, bank cameras, gas station cameras, traffic cameras, etc.) in proximity of a given vehicle under surveillance. Then a composite image from the vehicular 360 panoramic camera combined with the images/video obtained from the fixed security camera(s) will be presented for applications that may require a broader view of the environment or surroundings.

Having thus described preferred embodiments of the invention, advantages can be appreciated. Variations from the described embodiments exist without departing from the scope of the claims. Thus it is seen that video vehicle surveillance solutions are provided. Although particular embodiments have been disclosed herein in detail, this has been done for purposes of illustration only, and is not intended to be limiting with respect to the scope of the claims, which follow. In particular, it is contemplated by the inventors that various substitutions, alterations, and modifications may be made without departing from the spirit and scope of the invention as defined by the claims. For example, the camera 20 may be one or more still image cameras instead of a video camera. Since the camera captures images of the vehicle interior and uploads the same for, among other things, facial recognition, the system may be able to identify passengers in order to customize the journey experience of the passengers. For example by sending commands to the infotainment system or climate control system, a passenger's preferred music can be played and the temperature of the passenger cabin of the vehicle may be set for that passenger. Additionally, the camera nay support a request/response communication mechanism (built on the weave protocol or http/json or some other porotocol) such that after the consent of the owner, a third party computer system or program can send a set of commands exposed in the software development kit (“SDK”) or application programming interface (“API”). Appropriate actions will occur on the camera device and data and control messages may flow in a bidirectional manner. This capability is envisioned to enable an ecosystem of services/applications for both a stationary vehicle and moving vehicle. Some examples may include traffic estimation/alert applications, accident recording applications or tourism related video blogging applications. Requests can also be broadcasted or multi-casted to set of vehicles and based on an application set criterion, a subset of vehicles or a single vehicle may respond with desired results. This capability can open up applications like search, advertisement, etc. Further, live streaming mode may be supported in some configurations and the camera device can enable a video conference participation while in the vehicle. Multi vehicle participation integrated with social media platforms can be enabled as well. Other aspects, advantages, and modifications are considered to be within the scope of the following claims. The claims presented are representative of the inventions disclosed herein. Other, unclaimed inventions are also contemplated. The inventors reserve the right to pursue such inventions in later claims.

Insofar as embodiments of the invention described above are implemented, at least in part, using a computer system, it will be appreciated that a computer program for implementing at least part of the described methods and/or the described systems is envisaged as an aspect of the invention. The computer system may be any suitable apparatus, system or device, electronic, optical, or a combination thereof. For example, the computer system may be a programmable data processing apparatus, a computer, a Digital Signal Processor, an optical computer or a microprocessor. The computer program may be embodied as source code and undergo compilation for implementation on a computer, or may be embodied as object code, for example.

It is accordingly intended that all matter contained in the above description or shown in the accompanying drawings be interpreted as illustrative rather than in a limiting sense. It is also to be understood that the following claims are intended to cover all of the generic and specific features of the invention as described herein, and all statements of the scope of the invention which, as a matter of language, might be said to fall there between.

Having described the invention, what is claimed as new and secured by Letters Patent is:

1. A vehicle surveillance system comprising:
a camera located within said vehicle and configured to capture panoramic images;
said camera having a standby mode and an image capture mode;
a network connection;
a sensor in electrical communication with said camera;
said camera configured to change from said standby mode to said image capture mode in response to receipt of a signal from said sensor and to upload via said network connection at least one captured image for receipt by at least one of the devices from the list of devices consisting of a network based storage device and a monitoring device.

2. The vehicle surveillance system according to claim 1 wherein said camera includes a plurality of lenses.

3. The vehicle surveillance system according to claim 1 wherein said network connection includes a cellular connection.

4. The vehicle surveillance system according to claim 1 wherein said camera includes a plurality of cameras.

5. The vehicle surveillance system according to claim 1 further comprising an external camera in communication with said sensor and said camera, said external camera configured to be placed outside of said vehicle.

6. The vehicle surveillance system according to claim 1 wherein said at least one captured image is a still image.

7. The vehicle surveillance system according to claim 1 wherein said at least one captured image is a video image.

8. The vehicle surveillance system according to claim 1 further comprising another camera located proximal said camera; said another camera having a standby mode and an image capture mode; wherein said camera includes a camera identifier, said camera configured to transmit said camera identifier to said another camera; said another camera configured, subsequent to receiving said camera identifier, to change from said standby mode to said image capture mode in response to receipt of said signal from said sensor.

9. A method of vehicle surveillance, said method comprising:
setting up a panoramic camera within said vehicle;
setting said camera to standby mode;
said camera receiving a signal indicating a triggering event;
upon receiving said signal, said camera capturing at least one image; and
said camera uploading said image to a network based device.

10. The method according to claim 9 wherein said triggering event includes an event selected from the group of events consisting of movement detection, noise detection within said vehicle, and a perimeter breach and said network based device includes at least one device selected from the list of devices consisting of a storage device and a monitoring device.

11. The method according to claim 9 further comprising said cameral uploading said image via a cellular network.

12. The method according to claim 9 further comprising said camera capturing a plurality of images, wherein at least one image is a still image and at least one image is a video image and said uploading said image includes uploading said at least one still image within a minute of said at least one still image being captured.

13. The method according to claim 12 further comprising said camera placing a time stamp and a date stamp on said still image and on said video image.

14. The method according to claim 12 further comprising said camera storing said video image in a local storage and uploading said stored video to said monitoring device via WiFi.

15. The method according to claim 12 further comprising setting up an external camera distal from said vehicle, said distal camera capturing receiving said signal and said external camera capturing at least one image external to said vehicle in response to receipt of said signal.

16. The method according to claim 9, further comprising said camera detecting another camera within a predetermined distance from said camera;
in response to said detection, said camera transmitting an identifier to said another camera;
subsequent to said another camera receiving said camera identifier said another camera receiving said signal and capturing an image proximal said vehicle.

17. The method according to claim 16 further comprising said another camera uploading said proximal image to said monitoring device along with said identifier.

18. The method according to claim 9 further comprising analyzing said uploaded image with an analytic software.

19. The method according to claim 18 wherein said analytic software includes facial recognition software.

20. The method according to claim 12 further comprising said camera detecting another camera within a predetermined distance from said camera;
in response to said detection, said camera transmitting said video to said another camera; and said another camera storing said video image and uploading said stored video image to said monitoring device.
